(19) United States
(12) Patent Application Publication
(10) Pub. No.: US 2018/0058486 A1
(43) Pub. Date: Mar. 1, 2018

(54) Fastener for Thin-Sheet Materials

(71) Applicant: Penn Engineering & Manufacturing Corp., Danboro, PA (US)

(72) Inventor: Michael J. Maloney, Doylestown, PA (US)

(21) Appl. No.: 15/689,224

(22) Filed: Aug. 29, 2017

Related U.S. Application Data
(60) Provisional application No. 62/380,610, filed on Aug. 29, 2016.

(51) Int. Cl. F16B 5/02; F16B 5/00; F16B 37/02; F16B 37/06

(52) U.S. Cl. CPC F16B 5/02; F16B 5/0096; F16B 2037/007; F16B 37/068; F16B 37/02

(57) ABSTRACT

A cylindrical, internally-threaded part such as a nut or standoff that can be clinched into very-thin, sheet-metal panel even if the receiving hole is blind. The part has no integrally-formed displacer. The part is installed in an annular, blind hole by cold deforming and pushing material of the panel with a special installation tool into one or more recesses of the part. The tool has an annular cavity for receiving the fastener, an annular displacer surrounding the outer diameter of the annular cavity, and a center punch surrounded by the inner diameter of the cavity. One recess of the part may comprise an undercut in the outer periphery while another recess may comprise the groove of the internal threads. With a single stroke of the tool, panel material is simultaneously pushed into the undercut by the displacer and into the threads by the center punch to attach the part to the panel by clinching.

### REFERENCE TO RELATED APPLICATIONS

This is a non-provisional patent application of U.S. provisional patent application No. 62/380,610 entitled “Fastener for Thin Sheet Materials” filed on Aug. 29, 2016, priority from which is hereby claimed.

### FIELD OF THE INVENTION

The present invention relates to mechanical parts that can be assembled by clinching to thin metal panels. More particularly, the invention relates to clinch fasteners or standoffs that have no integrally-formed displacer and can therefore be clinched to sheet-metal panels that are thinner than ordinarily required using clinch fasteners having an integrally-formed displacer.

### BACKGROUND OF THE INVENTION

Applications frequently arise that require installation of a threaded fastener into a blind hole on a metal panel. While this can be done in some relatively thin materials, more often than not it is a cosmetic requirement that no blemish be visible on the backside surface of the panel after assembly. Prior art clinch fasteners have a displacer and an undercut at the bottom of the fastener. For proper installation, the depth of the blind hole in the metal panel must be at least as great as the full height of the displacer, undercut and shank. Additional panel thickness is also required below the hole to disperse installation stresses and to eliminate/reduce marking during installation. Preferably, the additional panel thickness should be great enough to enable blemish removal by a secondary finishing operation.

In the prior art, the metal panel for thin, sheet-metal panel applications, such as small consumer electronics, is made by initially providing a thick metal panel, and then reducing the weight and thickness by machining away material (reducing the thickness) in those areas where fasteners are not installed. This process is costly. It would be more efficient to provide a universally thin metal panel that could accommodate clinch fasteners.

As an alternative to clinch fasteners, some prior art methods disclose laser welding and adhesives to attach a fastener or standoff to a thin metal panel. These methods have proven to be impractical or not feasible in production due to material burn through or long cure times. Clinch type connections are preferable in these applications. Therefore, it would be desirable to provide a concealed clinching fastener, such as a standoff, which can be installed in a very thin metal panel and which leaves no blemish or mark on the backside of the receiving panel after installation.

### SUMMARY OF THE INVENTION

The invention provides a concealed, clinching part, such as a standoff, which leaves no blemish or mark on the backside of a very thin receiving panel of sheet metal. In a preferred embodiment, the invention comprises a cylindrical, internally-threaded part, such as a nut or standoff, which can be clinched to a very thin metal panel. The part is constructed and arranged to be installed in an annular, blind hole in the panel. During installation, panel material surrounding the outer diameter of the hole is cold deformed and pushed by a special installation tool into an undercut on the outer surface of the part. Simultaneously, panel material surrounding the inner diameter of the hole is cold deformed and pushed into an internally thread bore of the part. The combination of cold-deformation of metal material into the undercut and threads of the bore prevents pull-out of the fastener from the metal panel. Additionally, the combination of cold-deformation of metal material into the undercut and threads of the bore prevents rotation of the fastener relative to the metal panel, which allows a screw to be installed in the part without also turning the part.

In another embodiment, the invention comprises an assembly of a fastener attached to a blind hole in a sheet-metal panel, which has an annular, blind receiving hole. The inner diameter of the hole surrounds a central island of non-recessed panel material. The fastener preferably includes a central bore that is threaded with helical threads, and an undercut in the outer periphery of the fastener adjacent the bottom end. The fastener and panel are assembled by pressing against the panel in the area adjacent the inner and outer diameters of the hole while the fastener is seated in the hole. During pressing, the panel material is cold deformed and pushed into the undercut to lock the fastener to the panel. Preferably during pressing, panel material on the island is also cold deformed and pushed into the grooves of the threads in the bore.

The method of assembling a fastener to a metal panel as described above comprises the initial steps of providing a panel of sheet metal having an annular, blind receiving hole as described above and positioning the fastener in the hole. Next, the portion of the metal panel surrounding the inner and outer diameters of the hole is pressed into the undercut and simultaneously into a least one of the grooves of the fastener threads. Preferably, pressing is achieved using a specially designed tool. During this process, the tool does not press against the fastener because this pressure would place unwanted stress on the panel, which is very thin. The tool has a central annular cavity for receiving the fastener and a displacer at its bottom end. The displacer preferably has an outwardly-divergent bevel adapted to displace panel material into the undercut. The tool also has a center punch, which defines the inner diameter/boundary of the cavity. The center punch has a pointed end for displacing panel material outwardly into a groove of at least one of the threads simultaneously as material is forced into the undercut by the displacer.

In preferred embodiments, the displacer is formed on the installation tool, not on the fastener. Because the fastener has no displacer, the minimum depth of the hole in the metal panel can be greatly reduced. The reduction in hole depth is at least equal to the height of the displacer (if it were formed on the fastener), plus the depth to which the displacer would be pressed into the metal panel. As a result, the minimum thickness of the metal panel is also greatly reduced. The novel fastener can then be installed in much thinner metal panels compared to the prior art.

In a further embodiment, the invention comprises a combination of the novel fastener and the novel press tool. Because of their complementing design features, the press tool cold deforms panel material into the undercut and internal threads of the fastener without exerting any direct downward pressure on the fastener. The press tool and fastener operate cooperatively to greatly reduce the downward pressure exerted on the panel.

### BRIEF DESCRIPTION OF THE DRAWINGS

FIG. 1 is a front elevation in partial section of a fastener in accordance with a preferred embodiment of the invention;

FIG. 2A is a top plan view of a metal panel having a pre-formed, annular hole for assembly with the fastener of FIG. 1;

FIG. 2B is a cross-sectional view taken along line 2B-2B of FIG. 2A;

FIG. 3 is a cross-sectional view of the work portion of an installation tool in accordance with a preferred embodiment of the invention; and,

FIGS. 4 and 5 are cross-sectional, front elevations showing a press tool installed on a fastener and sequentially illustrating attachment of the fastener of FIG. 1 to a metal panel in accordance with a preferred embodiment of the invention.

### DESCRIPTION OF THE PREFERRED EMBODIMENT

As used herein, the term “annular hole” or “annular cavity” formed in an object means a hole or cavity generally having the geometrical shape of an annulus in a planar surface of the object, and said shape extends a depth into the surface of the object. As used herein, the “island” of an object means the solid portion of the object surrounded by an annular hole or annular cavity. The inner diameter of the annulus defines the outer diameter of the island.

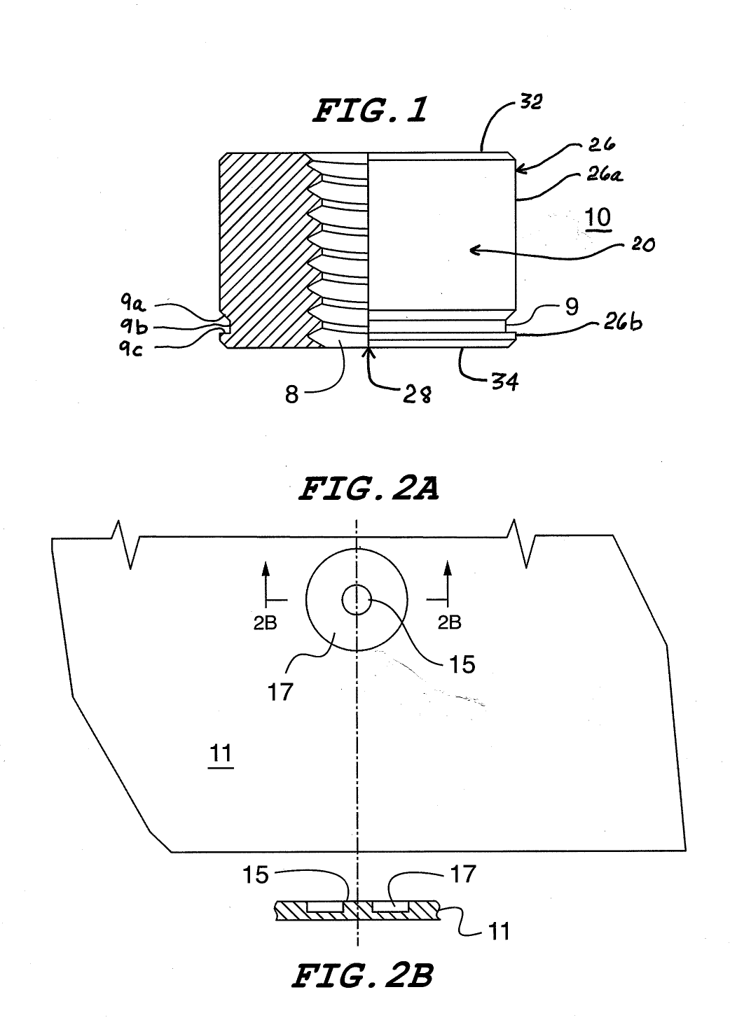

A standoff fastener (or simply “standoff”) in accordance with a preferred embodiment of the invention is shown in FIG. 1 and is designated generally by reference numeral 10. In this preferred embodiment, the fastener has a cylindrically-shaped body 20 with a top 32, bottom 34, and outer peripheral surface 26. The top 32 and bottom 34 surfaces of the fastener are generally flat, while the outer peripheral surface is generally cylindrical. The height of the fastener is the distance from the top 32 to the bottom 34.

A central bore 28 extends axially through the body 20 from the top 32 to the bottom 34. In the preferred embodiment shown in FIG. 1, the central bore 28 is threaded with, for example, helical threads 8 that extend along the entire length of the bore 28 and most importantly to the bottom 34 of the body 20. In other preferred embodiments, the central bore 28 may be unthreaded or smooth. In other embodiments, the threads may extend along only a portion or portions of the bore 28.

An undercut 9 is formed in the lower portion of the outer peripheral surface 26 adjacent the bottom 34. Proceeding from top to bottom, the undercut is defined by a first oblique surface 9a, a second annular, reduced-diameter surface 9b, and a third radially-extending shoulder surface 9c. In a preferred embodiment, the lower portion of the outer peripheral surface 26 between the shoulder 9c and the bottom 26 (hereinafter referred to as the “shank 26b”) has the same diameter as the upper portion 26a of the outer peripheral surface 26. More importantly, the shank 26b has a very small height measured axially from the bottom 26 to the shoulder 9 as best seen in FIG. 1.

As described below, the undercut 9, very short shank 26b, and internal threads 8 enable the fastener 10 to be permanently affixed by clinching to any substrate such as a sheet-metal panel 11. The mechanical connection prevents separation as well as rotation of the fastener 10 relative to the metal panel 11. Like many prior art clinch fasteners, the fastener 10 includes an undercut 9; however, in contrast with many prior art clinch fasteners, the fastener 10 does not have a displacer that cold deforms material from the metal panel 11. Because the fastener has no displacer, the fastener 10 can be installed in a hole that is much shallower than the hole typically required for prior art clinch fasteners having a displacer. The difference in hole depth between a prior art hole and hole for the inventive fastener 10 is equal to the thickness (or height) of the displacer itself plus the depth to which the displacer would be pressed into the panel. This hole-depth saving feature is very important and enables this fastener 10 to be installed on very thin metal panels.

FIG. 2A illustrates the geometry of the hole in which the fastener 10 of this preferred embodiment is installed. In this embodiment, the metal panel 11 has an annular, blind hole 17 defined by an inner diameter, an outer diameter, and hole depth. The inner and outer diameters are represented by the concentric circles in FIG. 2A and the depth is the axial dimension of the hole shown in FIG. 2B. The center area or “island” 15 surrounded by the hole 17 is non-recessed and undisturbed. The annular hole 17 and island 15 have the appearance of doughnut. A cross-section of the metal panel 11 surrounding the annular hole 17 is shown in FIG. 2B and shows the dimensional relationship between the center island 15, the annular hole, and the metal panel surrounding the hole 17.

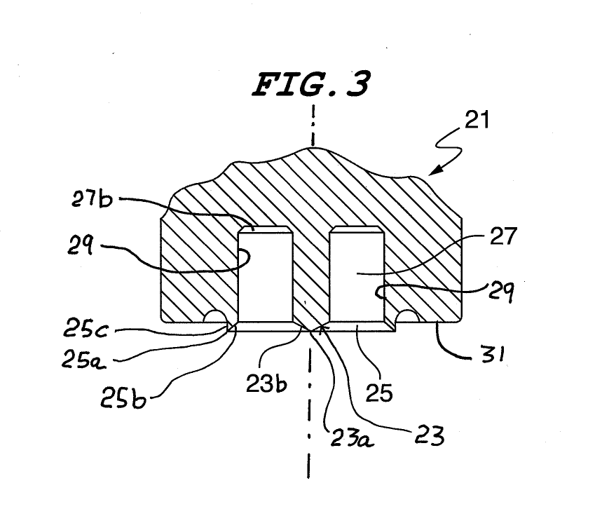

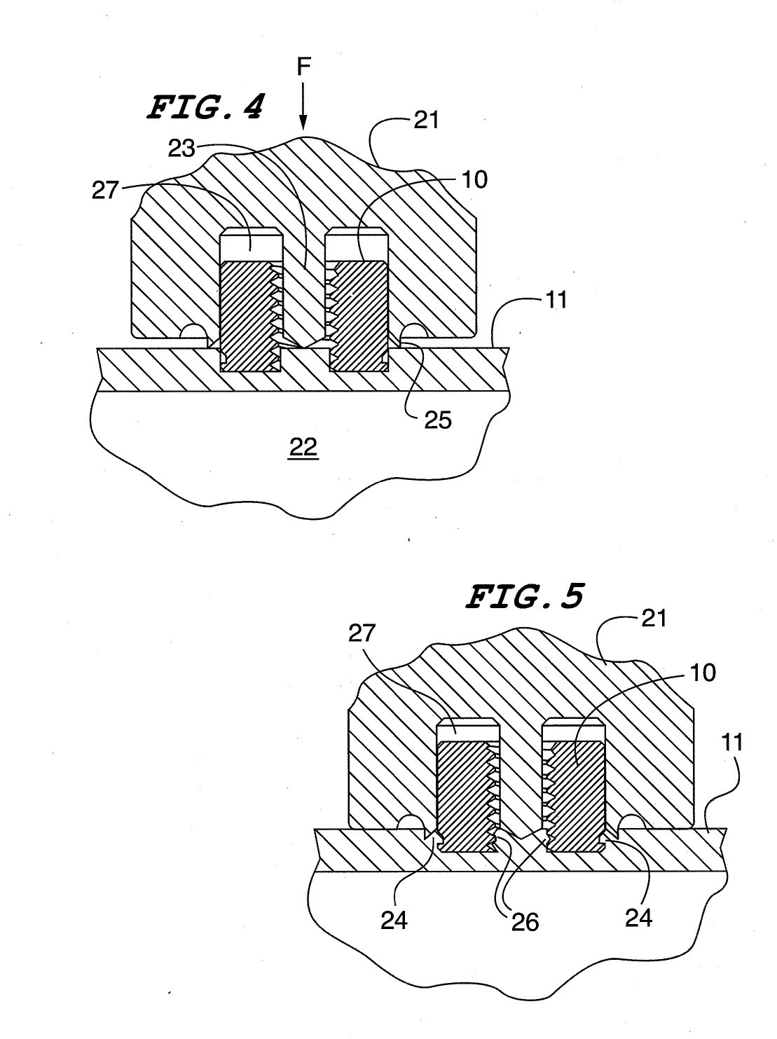

As described above, the clinch fastener 10 does not have a displacer. Instead, the fastener 10 is clinched to the metal panel using a press tool 21 as shown, for example, in FIG. 3. The press tool 21 cold deforms metal from a concentric area of the panel 11 surrounding the outer diameter of the hole 17 into the undercut 9 as shown in FIGS. 4 and 5. The press tool 21 also cold deforms metal from a concentric area of the island 15 into the internal threads 8 of the fastener 10.

The tool 21 has a concentric construction about a central axis and has a central, annular cavity 27 having a shape that complements the shape of the fastener for receiving the fastener 10. The annular cavity is formed in the distal, work surface 31 of the tool. The inner diameter of the annular cavity 27 is bounded by a center punch 23 having a pointed tip 23a formed by a conical surface 23b oblique relative to the central axis of the tool 21. The base of the center punch 23 is preferably cylindrical and has an outer diameter slightly smaller than the internal diameter of the central bore 28 of the fastener 10. The outer diameter of the annular cavity 27 is bound by a cylindrical wall 29 having a slightly larger diameter than the outer diameter of the fastener body 20. The depth of the cavity 27 is preferably greater than the height of the fastener 10.

In a preferred embodiment, the bottom 27b of the cavity 27 has a tapered end surface that complements the tapered top surface 22 of the fastener. The top of the cavity 27 terminates proximate the work surface 31 of the tool 21.

The tool 21 has a displacer 25 integrally formed on the work surface 31 immediately adjacent the outer cylindrical wall 29 of the cavity 27. In a preferred embodiment, the displacer 25 has a ring shape and extends axially from the work surface 31 to a distal pointed tip 25a formed by an oblique surface 25b and an axial surface 25c relative to the central axis of the tool 21. In a preferred embodiment, the tip of the center punch 23a and the tip of the displacer 25a extend axially an equal distance from the work surface 31 as best seen in FIG. 3.

A method of clinch fastening the fastener 10 to a metal panel 11 using the press tool 21 in accordance with a preferred embodiment of the invention is illustrated in FIGS. 4 and 5. The metal panel 11 has the annular hole 17 preformed in it. The fastener 10 is initially positioned with its bottom 34 and undercut 9 within the annular hole 17. The press tool is then installed over/surrounding the fastener 10 as seen in FIG. 4 before the clinching process is initiated. In this position the tips of the center punch 23 and displacer 25 rest on the upper surface of the metal panel 11.

When a downward force “F” is applied to the press tool 21, the center punch 23 and displacer 25 impinge the upper surface of the metal panel and cold deform the metal panel in the areas immediately adjacent the threads 8 and the undercut 9. The tip 23a of the center punch 23 impinges on the island 15 and cold deforms the metal panel 11 by displacing metal concentrically, radially-outwardly into the threads 8 proximate the bottom of the fastener 10. In addition to preventing separation, cold deformation of the metal panel into the threads 8 helps prevent the fastener 10 from rotating relative to the panel 11. The tip of the displacer 25 impinges on and cold deforms the metal panel by displacing metal concentrically, radially-inwardly into the undercut 9. FIG. 5 shows the fastener 10 after it has been clinched to the metal panel 11 by the press tool 21.

During the process of assembling the fastener 10 to the metal panel 11 by clinching, the press tool 21 only presses against the metal panel 11, which is supported by an anvil 22. To insure that the press tool 21 does not press on the fastener, the depth of the hole 27 in the tool is greater than the height of the fastener 10. FIG. 5 shows that even after the fastener 10 is clinched to the metal panel, there is sufficient clearance above the top of the fastener body.

FIGS. 4 and 5 illustrate that the tool 21 cannot exert a direct downward force on any other part of the fastener. The diameter of the hole 27 is slightly larger than the outer diameter of the fastener 10, and the outer diameter of the center punch 23 is slightly smaller than the diameter of the inner bore 28.

It should be understood that the embodiments described herein are merely exemplary and that a person skilled in the art may make many variations and modifications without departing from the spirit and scope of the invention. Accordingly, all such variations and modifications are intended to be included within the scope of the embodiments described herein as defined in the appended claims. For example, while the fastener 10 was illustrated and described with reference to a mechanical standoff for a metal panel, the invention is not limited to a standoff and could be any threaded or unthreaded member having an undercut in the appropriate location for receiving the cold flow of material from the metal panel.

1. An assembly of a fastener attached to a blind hole in a sheet-metal panel, comprising;
a panel of sheet metal having an annular, blind receiving hole defined by an inner diameter, and outer diameter and a depth, said hole surrounding a central island of non-recessed panel material;
a fastener having a top end, a bottom end, a height, an outer periphery, a central bore with helical threads, and an undercut in said outer periphery located adjacent said bottom end; and
wherein the bottom end of the fastener occupies said hole and material of the panel occupies said undercut.

2. The assembly of claim 1, wherein panel material also occupies grooves of the threads.

3. A method of assembling a member to a panel of sheet metal, comprising the steps of:
providing a panel of sheet metal having an annular, blind receiving hole defined by an inner diameter, an outer diameter and a depth, said hole surrounding a central island of non-recessed panel material;
providing a member with an undercut along its outside periphery adjacent a bottom end thereof;
placing at least a portion of the member in the hole; and
pressing a tool against the panel whereby material of the panel surrounding the member is forced into the undercut.

4. The method of claim 3 wherein the member comprises a fastener having a top, a bottom, a height, and a central bore with helical threads.

5. The method of claim 4 whereby the step of pressing the tool against the panel also forces material of the panel into at least one groove of the threads that extend from the top to the bottom along the entire length of the central bore of the fastener.

6. The method of claim 3 wherein the tool does not press against the fastener.

7. The method of claim 3 wherein the tool has a displacer at a bottom end thereof with an outwardly divergent bevel adapted to displace panel material into the undercut.

8. The method of claim 4 wherein the tool has an annular cavity for receiving the fastener, said cavity having a height substantially greater than the height of the fastener.

9. The method of claim 4 wherein the tool has center punch surrounded by the cavity and having a pointed end for displacing panel material outwardly into a groove of at least one of the threads simultaneously as material is forced into the undercut.

10. The assembly of claim 9, wherein the fastener lacks a displacer for forcing material of the panel into the undercut and the tool is the only means for displacing material of the panel against the fastener.
